(19) United States
(12) Patent Application Publication
(10) Pub. No.: US 2026/0303728 A1
(43) Pub. Date: Oct. 1, 2026

(54) INFORMATION PROCESSING APPARATUS AND DISPLAY METHOD

(71) Applicant: SHARP KABUSHIKI KAISHA, Osaka (JP)

(72) Inventor: KANJI NAKAGAWA, Osaka (JP)

(21) Appl. No.: 19/574,079

(22) Filed: Mar. 20, 2026

(30) Foreign Application Priority Data
Mar. 25, 2025 (JP) 2025-050156

(51) Int. Cl. H04N 1/00; G06F 3/04817; G06F 11/1446; H04N 1/21

(52) U.S. Cl. CPC H04N 1/00076; G06F 3/04817; G06F 11/1458; H04N 1/00037; H04N 1/21; G06F 2201/805; H04N 2201/0094

(57) ABSTRACT

An information processing apparatus includes: a display; a storage medium; an inspector that inspects the storage medium; and one or more controllers, wherein the one or more controllers, when an inspection result indicating that a state of the storage medium is a replacement timing is obtained by an inspection by the inspector, display, on the display, a warning screen including a first message notifying the replacement timing of the storage medium, and a second message prompting backup of the storage medium and contact with a dealer.

### CROSS-REFERENCE TO RELATED APPLICATION

The present application claims priority from Japanese Application JP2025-050156, the content to which is hereby incorporated by reference into this application.

### BACKGROUND OF THE INVENTION

### 1. Field of the Invention

The disclosure relates to an information processing apparatus and the like.

### 2. Description of the Related Art

For example, in the related art, a data processing apparatus is known that, when it is determined that the end-of-life of a non-volatile memory is approaching, issues a warning to that effect and displays a prompt for backing up data.

### SUMMARY OF THE INVENTION

The disclosure has as one of its objects to provide, for example, an information processing apparatus capable of providing appropriate notification to a user at a replacement timing of a storage medium.

An information processing apparatus of the disclosure includes a display, a storage medium, an inspector that inspects the storage medium, and one or more controllers, in which the one or more controllers, when an inspection result indicating that a state of the storage medium is a replacement timing is obtained by an inspection by the inspector, display, on the display, a warning screen including a first message notifying the replacement timing of the storage medium, and a second message prompting backup of the storage medium and contact with a dealer.

A display method of the disclosure includes an inspection step of inspecting a storage medium, and when an inspection result indicating that a state of the storage medium is a replacement timing is obtained by an inspection in the inspecting step, a display step of displaying a warning screen including a first message notifying the replacement timing of the storage medium, and a second message prompting backup of the storage medium and contact with a dealer.

According to the disclosure, for example, it becomes possible to provide an information processing apparatus capable of providing appropriate notification to a user at a replacement timing of a storage medium.

### BRIEF DESCRIPTION OF THE DRAWINGS

FIG. 1 is a diagram illustrating an overview of an apparatus according to a first embodiment.

FIG. 2 is a diagram illustrating the configuration of hardware of the apparatus according to the first embodiment.

FIG. 3A is a diagram illustrating the configuration of software of the apparatus according to the first embodiment.

FIG. 3B is a diagram illustrating an example of a flag according to the first embodiment.

FIG. 4 is a diagram illustrating a flow of main processing according to the first embodiment.

FIG. 5 is a diagram illustrating a flow of button processing of a warning message in the first embodiment.

FIG. 6 is a diagram illustrating a flow of contact message processing to a dealer in the first embodiment.

FIG. 7 is a diagram illustrating a flow of backup screen processing in the first embodiment.

FIG. 8A is a diagram illustrating an example of an operation example in the first embodiment.

FIG. 8B is a diagram illustrating an example of an operation example in the first embodiment.

FIG. 9A is a diagram illustrating an example of an operation example in the first embodiment.

FIG. 9B is a diagram illustrating an example of an operation example in the first embodiment.

FIG. 10A is a diagram illustrating an example of an operation example in the first embodiment.

FIG. 10B is a diagram illustrating an example of an operation example in the first embodiment.

FIG. 11A is a diagram illustrating an example of an operation example in the first embodiment.

FIG. 11B is a diagram illustrating an example of an operation example in the first embodiment.

FIG. 12A is a diagram illustrating an example of an operation example in the first embodiment.

FIG. 12B is a diagram illustrating an example of an operation example in the first embodiment.

FIG. 13A is a diagram illustrating an example of an operation example in the first embodiment.

FIG. 13B is a diagram illustrating an example of an operation example in the first embodiment.

### DETAILED DESCRIPTION OF THE INVENTION

Embedded devices incorporating information processing apparatuses, such as multifunction peripherals and multifunction peripheral/printer (MFPs), often incorporate storage that is capable of continuous use up to a standard product lifetime. However, when an inexpensive storage device is used for cost reduction, such inexpensive storage devices often have a short product lifetime, which makes failures or reaching the end of the storage lifetime more likely to occur, resulting in disadvantages in terms of customer satisfaction and service costs.

Further, in a case where storage replacement is performed after the storage has failed or reached the end of its lifetime, there are cases where customer data is lost or recovery processing of such data requires a long time and incurs significant service costs, thereby developing into compensation issues for customers, which has been a problem.

An information processing apparatus for solving such problems will be described below in embodiments with reference to the drawings. It is to be noted that the embodiments described below are merely examples for explaining the contents described in the claims, and the technical scope of the disclosure is not limited to the descriptions of these embodiments.

### 1. First Embodiment

Hereinafter, a first embodiment will be described. Note that the first embodiment will be described using the following as an example. In the following embodiment, a case will be described where an information processing apparatus of the disclosure is applied to an image forming apparatus. However, the information processing apparatus may be applied to other apparatuses.

### 1.1 Overall Configuration

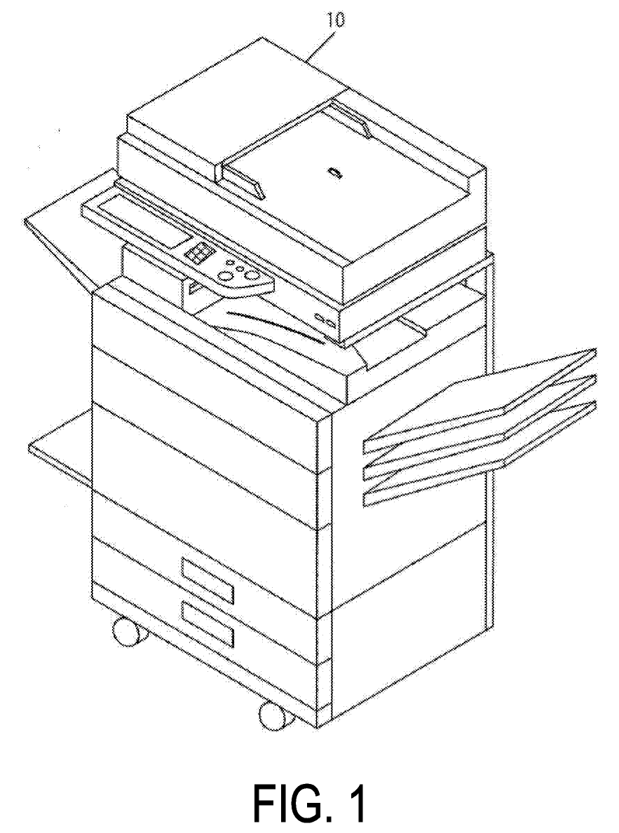

FIG. 1 is a diagram illustrating an overview of an image forming apparatus 10.

The image forming apparatus 10 is, for example, a multifunction peripheral or a device called an MFP. For example, when executing a job (print job), the image forming apparatus 10 can form an image on a sheet that is a recording medium. The image forming apparatus 10 can execute jobs for a plurality of functions including copy function, FAZ function, scan function, and print function.

The information processing apparatus of the disclosure is applicable not only to an MFP but also to, for example, single-function image processing apparatuses or image forming apparatuses such as scanners and printers, or information processing apparatuses such as smartphones and tablets. Further, the information processing apparatus may be a home appliance equipped with an IoT function (for example, an air conditioner, a refrigerator, or a television), a portable apparatus, or an in-vehicle apparatus (for example, a car navigation system).

### 1.2 Hardware Configuration

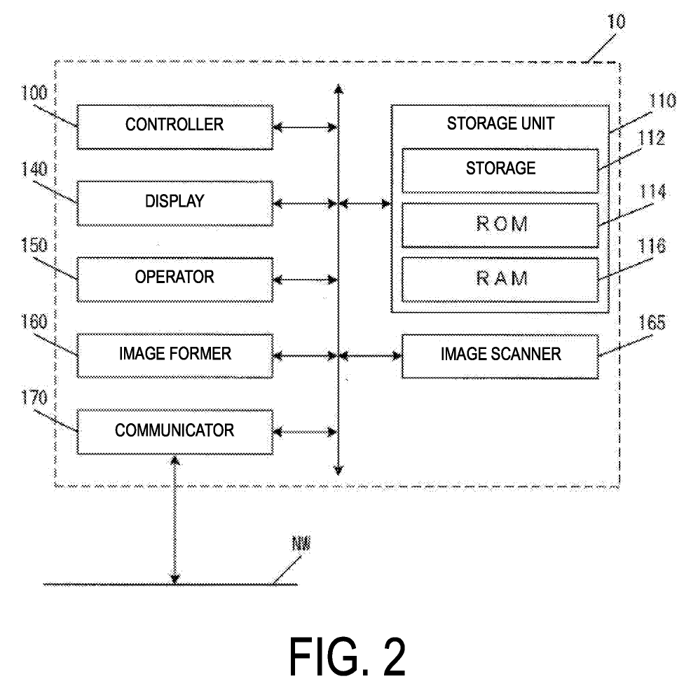

FIG. 2 illustrates a hardware configuration of the image forming apparatus 10 as a representative apparatus among the apparatuses included in the disclosure, and will be described below with reference to the drawing. FIG. 2 is a diagram illustrating an example of the image forming apparatus 10. The image forming apparatus 10 also has general functions as necessary.

As illustrated in FIG. 2, the image forming apparatus 10 includes a controller 100, a storage unit 110 including a storage 112, a read only memory (ROM) 114, and a random access memory (RAM) 116, a display 140, an operator 150, an image former 160, an image scanner 165, and a communicator 170.

The controller 100 controls the image forming apparatus 10 as a whole. The controller 100 enables various functions by loading and executing various programs stored in the storage unit 110 (for example, the storage 112 or the ROM 114). The controller 100 may be implemented by one or a plurality of control apparatuses/arithmetic apparatuses (central processing unit (CPU) or system on a chip (SoC)). The controller 100 may include one or a plurality of control circuits.

The storage unit 110 is one or more storage apparatuses in which various programs and various data necessary for an operation of the image forming apparatus 10 are stored. The storage unit 110 is configured by, for example, the storage 112, the ROM 114, and the RAM 116.

The storage 112 is a non-volatile storage medium capable of storing programs and data. In the present embodiment, the storage 112 is preferably configured by a NAND (Not AND)-type storage medium such as an embedded Multi Media Card (eMMC). For example, there are cases where the controller 100 performs writing to the eMMC during execution of a job. In such cases, when another storage medium (for example, a solid state drive (SSD)) is not provided, writing to the eMMC increases, making failures or reaching the end of the storage lifetime more likely to occur.

Further, the storage 112 is not limited to an eMMC, and may be configured by other NAND-type storage media, such as other semiconductor memories including an SSD and a Universal Flash Storage (UFS), or magnetic storage media such as a Hard Disk Drive (HDD).

The ROM 114 is a non-volatile memory capable of holding programs and data even in a case that the power is turned off.

The RAM 116 is a main memory mainly used when the controller 100 executes processing. The RAM 116 is a rewritable memory that temporarily holds a program loaded from the storage 112, the ROM 114 or the like, and data including processing execution results.

The display 140 is a display apparatus that can display various types of information and various screens such as an execution screen. The display 140 may be, for example, a display apparatus such as a liquid crystal display (LCD), an organic electro-luminescence (EL) display, or an electrophoresis display. The display 140 includes an interface to which the display apparatus can be connected. For example, the display may include an external display apparatus connected via a high-definition multimedia interface (HDMI; trade name), a digital visual interface (DVI), or a display port.

The operator 150 is an operation apparatus that allows a user to input an operation. For example, the operator may be software keys displayed on a touch panel integrated with the display 140 or hardware keys such as operation buttons. The operator 150 may be an operation apparatus such as a keyboard or a mouse, for example. The operator 150 may also include an interface (USB, for example) to which an operation apparatus can be connected. For example, the image forming apparatus 10 may be connected to different operation apparatuses (keyboard, mouse, and the like) via an interface.

The image former 160 forms an image on, for example, a recording sheet. The image former 160 includes, for example, an image carrier, and forms an image by forming a toner image on the image carrier and transferring the toner image on the image carrier onto the recording sheet. The image former 160 may be configured as an image forming apparatus such as a printer. The image former 160 may electronically form an image as an image file.

The image scanner 165 scans a document (image) and outputs the document as image data. The image scanner 165 is, for example, a scanner, and may be a reading apparatus that utilizes a charge coupled device (CCD), a contact image sensor (CIS), or a complementary metal-oxide-semiconductor (CMOS) image sensor.

The communicator 170 is a communication interface that communicates with other apparatuses. The communicator may be, for example, a network interface capable of providing wired connection or wireless connection. In the present embodiment, communication with other apparatuses is possible via a network NW.

A network (NW) connecting the image forming apparatus 10 may be any communication line or communication system and may utilize a local area network (LAN) that utilizes wired or wireless technology, a virtual local area network (VLAN), the Internet, or a public line network, or a communication system such as mobile communication (mobile communication such as 4G/5G/6G, for example) or a next-generation telephone network, for example.

### 1.3 Software Configuration

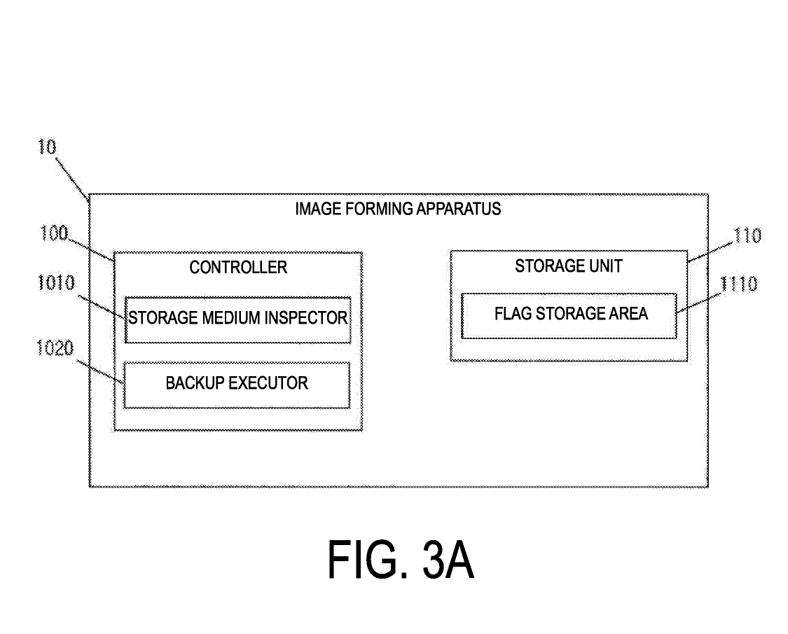

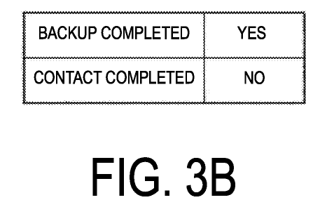

A main software configuration of the image forming apparatus 10 included in the disclosure will be described with reference to FIG. 3A. Note that, in the software configuration illustrated in FIG. 3A, configurations necessary for the present embodiment are mainly described, and other configurations are omitted.

First, the main software configuration of the image forming apparatus 10 will be described. For example, the controller 100 can realize a storage medium inspector 1010 and a backup executor 1020 by reading and executing programs stored in the storage 112 and the ROM 114.

The storage medium inspector 1010 inspects a storage medium and outputs an inspection result corresponding to a state of the storage medium. In the present embodiment, the storage medium inspector 1010 outputs one of inspection results of “normal,” “faulty”, “end of life”, and “replacement timing” by inspecting the storage medium.

Here, the state of the storage medium being “faulty” refers to, for example, a state in which the storage medium is not usable, such as a state in which writing to the storage medium cannot be performed or there is no response from the storage medium. Further, the state of the storage medium being “end of life” refers to a state in which the storage medium is operating but correct operation is not guaranteed, a state in which a write and/or read error has occurred, or a state involving risk in use.

The state of the storage medium being “replacement timing” refers to a state in which the risk is not as high as in the “end of life” state, but replacement of the storage medium is preferable. For example, compared with the “end of life” state, the risk in use is not high, but continued use may cause transition to the “end of life” state. Further, the state of the storage medium being “replacement timing” refers to a state in which a write and/or read error has not occurred, but there is a risk of occurrence in the future.

That is, the storage medium transitions from a “normal” state to an “end of life” state via a “replacement timing” state. Further, the storage medium may transition from any state to a “faulty” state. As methods for the storage medium inspector 1010 to inspect the storage medium, one or more of the following methods can be considered.

### (1) Inspection based on Response State from Storage Medium

For example, when there is no response from the storage medium, the storage medium inspector 1010 outputs an inspection result indicating that the state of the storage medium is “faulty.”

### (2) Inspection based on Operating Time of Storage Medium

For example, when the operating time of the storage medium becomes equal to or greater than a first threshold value, the storage medium inspector 1010 outputs an inspection result indicating that the state of the storage medium is “end of life.” Further, when the operating time of the storage medium becomes equal to or greater than a second threshold value, the storage medium inspector 1010 outputs an inspection result indicating that the state of the storage medium is “replacement timing”.

### (3) Inspection based on Spare Blocks of Storage Medium

For example, when a storage area of spare blocks used in the storage medium becomes equal to or less than a first threshold value, the storage medium inspector 1010 outputs an inspection result indicating that the state of the storage medium is “end of life.” Further, when the storage area of spare blocks used in the storage medium becomes equal to or less than a second threshold value, the storage medium inspector 1010 outputs an inspection result indicating that the state of the storage medium is “replacement timing.” Here, the spare blocks refer to spare storage areas in the storage medium that can be used as substitutes for defective blocks that have become unusable due to some failure in the storage area.

Further, information on spare blocks of the storage medium may be obtained by the controller 100 from self-diagnostic data of the storage 112, or may be obtained by executing a predetermined command.

### 4) Inspection based on Number of Job Executions in Image Forming Apparatus 10

For example, when the number of job executions in the image forming apparatus 10 becomes equal to or greater than a first threshold value, the storage medium inspector 1010 outputs an inspection result indicating that the state of the storage medium is “end of life”. Further, when the number of job executions of the storage medium becomes equal to or greater than a second threshold value, the storage medium inspector 1010 outputs an inspection result indicating that the state of the storage medium is “replacement timing”.

### (5) Inspection based on Number of Write operations of Storage Medium

For example, when the number of write operations of the storage medium becomes equal to or greater than a first threshold value, the storage medium inspector 1010 outputs an inspection result indicating that the state of the storage medium is “end of life”. Further, when the number of write operations of the storage medium becomes equal to or greater than a second threshold value, the storage medium inspector 1010 outputs an inspection result indicating that the state of the storage medium is “replacement timing”.

### (6) Inspection based on SMART parameters

The storage medium inspector 1010 may output an inspection result based on various parameters obtained from self-monitoring, analysis and reporting technology (SMART).

The backup executor 1020 performs backup processing in which data derived from a user stored in the storage 112 as a storage medium is stored in an external storage medium, such as a USB memory. Examples of data derived from a user include setting values, an address book, registered users, and document data. The backup executor 1020 may back up only a part of the data derived from a user stored in the storage 112.

Further, the storage unit 110 secures a flag storage area 1110 for storing flags. An example of management information stored in the flag storage area 1110 will be described with reference to FIG. 3B. In the present embodiment, the flags store a type of flag (for example, “backup completed” and “contact completed”) and a value (for example, “Yes” or “No”).

### 1.4 Flow of Processing

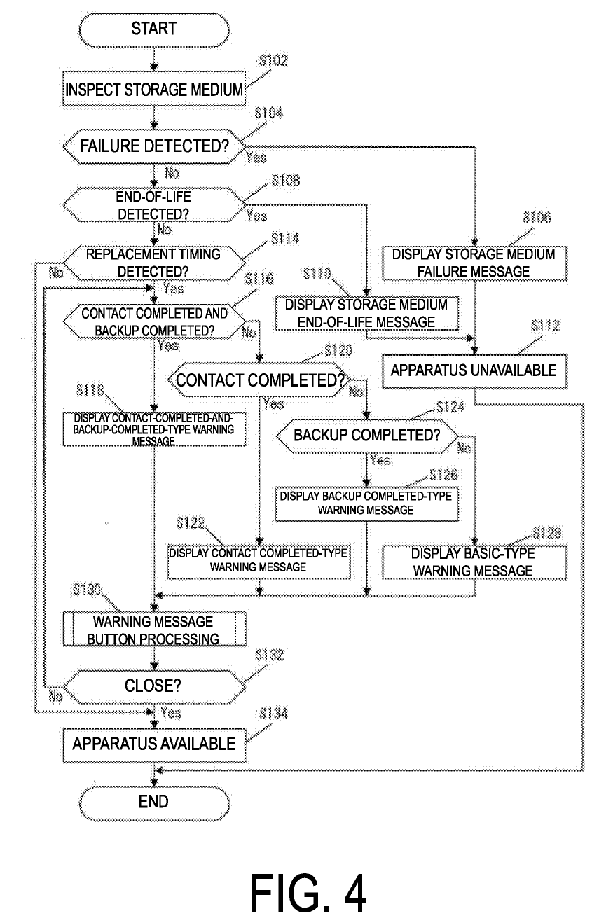

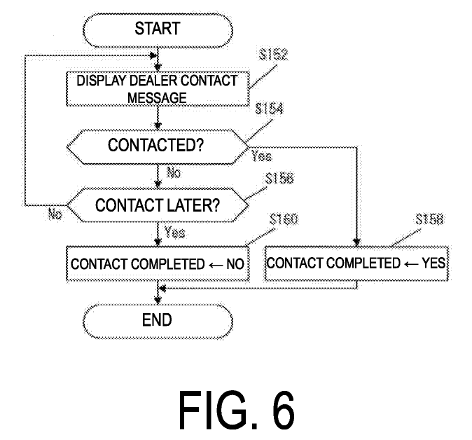

A processing flow in the present embodiment will be described below with reference to FIGS. 4 to 7. FIG. 6 is a diagram illustrating a flow of setting screen display processing. Note that the configuration described with reference to FIG. 2 or FIG. 3 may execute the processing of each step.

### 1.4.1 Flow of Main Processing

FIG. 4 is a diagram illustrating a flow of main processing. First, the controller 100 inspects a storage medium (S102). A predetermined timing is set as a timing at which the controller 100 inspects the storage medium. For example, the storage medium may be inspected at the following timings.

### (1) Inspecting Storage Medium at Timing of Startup of Apparatus

For example, the controller 100 may inspect the storage medium when the image forming apparatus 10 is started.

### (2) Inspecting Storage Medium at Timing of Return from Energy-saving State of Apparatus

For example, the controller 100 may inspect the storage medium when the image forming apparatus 10 recovers from a power-saving state, such as an energy-saving mode, to a normal power state.

### (3) Inspecting Storage Medium at Predetermined Timing Once Per Day.

The controller 100 may execute the inspection of the storage medium at a predetermined time once per day, for example.

Further, a user may be allowed to set a timing at which the storage medium is inspected, and the controller 100 may inspect the storage medium at the timing set by the user.

Next, the controller 100 determines whether a “faulty” state of the storage medium has been detected (S104). Here, when “faulty” is output as an inspection result of the storage medium, the controller 100 determines that a “faulty” state of the storage medium has been detected.

When the controller 100 determines that a “faulty” state of the storage medium has been detected, on the display unit 140, a storage failure message that notifies that the storage has failed (S104; Yes → S106). On the other hand, when the controller 100 determines that a “faulty” state of the storage medium has not been detected, the controller 100 determines whether an “end of life” state of the storage medium has been detected (S104; No → S108).

Here, when “end of life” is output as an inspection result of the storage medium, the controller 100 determines that an “end of life” state of the storage medium has been detected. When the controller 100 determines that an “end of life” state of the storage medium has been detected, on the display 140, a storage end-of-life message that notifies that the storage has reached its end of life is displayed (S108; Yes → S110).

After displaying the storage failure message or the storage end-of-life message, the controller 100 executes apparatus unusable processing (S112). The apparatus unusable processing may include, for example, processing that disables execution of jobs in the image forming apparatus 10 and execution of backup by persons other than a serviceman.

On the other hand, when the controller 100 determines that an “end of life” state of the storage medium has not been detected, the controller 100 determines whether a “replacement timing” state of the storage medium has been detected (S108; No → S114). Here, when “replacement timing” is output as an inspection result of the storage medium, the controller 100 determines that a “replacement timing” state of the storage medium has been detected.

When the controller 100 determines that a “replacement timing” state of the storage medium has been detected, the controller 100 determines whether “contact completed” and “backup completed” are satisfied (S114; Yes → S116).

It should be noted that, when the controller 100 detects any one of a “faulty,” “end of life,” or “replacement timing” state of the storage medium, the controller 100 may skip inspection of the storage 112 until the storage medium is replaced, and may execute processing from S116.

Here, in the present embodiment, when values of both “contact completed” and “backup completed” in the flag storage area 1110 of the storage unit 110 are “yes”, the controller 100 determines that both “contact completed” and “backup completed” are satisfied.

When the controller 100 determines that both “contact completed” and “backup completed” are satisfied, the controller 100 displays a contact-completed-and-backup-completed-type warning message on the display 140 (S116; Yes → S118).

Here, the warning message is a warning message including a first message notifying a replacement timing of the storage medium and a second message prompting backup of the storage medium and/or contact with a dealer. The contact-completed-and-backup-completed-type warning message is a warning message including a second message having content based on completion of backup and completion of contact with the dealer.

On the other hand, when the controller 100 determines that both “contact completed” and “backup completed” are not satisfied, the controller 100 determines whether “contact completed” is satisfied (S116; No → S120).

When the controller 100 determines that “contact completed” is satisfied, the controller 100 displays a contact completed-type warning message on the display 140 (S120; Yes → S122). On the other hand, when the controller 100 determines that “contact completed” is not satisfied, the controller 100 determines whether “backup completed” is satisfied (S120; No → S124). The contact completed-type warning message is a warning message including a second message having content that prompts backup and is based on completion of contact with the dealer.

When the controller 100 determines that “backup completed” is satisfied, the controller 100 displays a backup-completed-type warning message on the display 140 (S124; Yes → S126). The backup-completed-type warning message is a warning message including a second message having content that prompts contact with the dealer and is based on completion of backup.

On the other hand, when the controller 100 determines that “backup completed” is not satisfied, the controller 100 displays a basic-type warning message on the display 140 (S124; No → S128). The basic-type warning message is a warning message including a second message having content that prompts backup and prompts contact with the dealer.

After displaying each warning message, the controller 100 executes button processing of the warning message (S130). The button processing of the warning message is processing in which, for example, when a display button included in the warning message is selected, processing corresponding to the selected display button is executed. The display button may be displayed as an icon. Details of the button processing of the warning message will be described later.

Further, after displaying the warning message, the controller 100 may continuously display an icon in a specific area of the display 140, for example, until replacement of the storage medium is performed by a serviceman.

The icon herein means pictures, pictographs, symbols, and characters displayed on the display screen to represent various types of data and processing functions, for example. When the user selects an icon, the controller 100 can execute the processing set for the icon.

Next, the controller 100 determines whether an operation to close the warning message has been performed (S132). As a method of determining that the operation to close the warning message has been performed, for example, in the button processing of the warning message in S130 described later, when a close button is selected by the user, the controller 100 may determine that the close operation has been performed.

When the controller 100 determines that the operation to close the warning message has not been performed, the controller 100 determines whether both “contact completed” and “backup completed” are satisfied (S132; No → S116). That is, when a button other than the close button is selected by the user, the controller 100 continues to display a warning message corresponding to the selected button.

On the other hand, when the controller 100 determines that the operation to close the warning message has been performed, the controller 100 ends the processing with the apparatus in a usable state (S132; Yes → S134). Further, when the controller 100 determines that a “replacement timing” state of the storage medium has not been detected, the controller 100 similarly ends the processing with the apparatus in a usable state (S114; No → S134).

Note that the above-described operation flow is an example, and partially different processing may be performed. For example, after the user closes the warning message, when the user selects an icon displayed in a specific area, the controller 100 may directly display the warning message. Further, for example, when the icon displayed in the specific area is selected, the controller 100 may skip processing of S102 to S114 and start the flow from S116 to display the warning message.

### 1.4.2 Flow of Button Processing of Warning Message

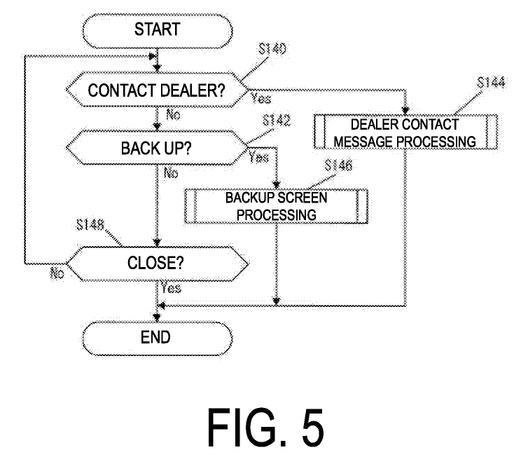

FIG. 5 is a diagram illustrating a flow of button processing of a warning message. First, the controller 100 determines whether an operation to contact a dealer has been selected by the user (S140). In the present embodiment, it is assumed that the user selects a display button or an icon.

When the operation to contact the dealer has been selected by the user, the controller 100 executes dealer contact message processing (S140; Yes → S144).

Here, the dealer contact message processing is processing in which a notification screen including a message prompting contact with the dealer is displayed on the display 140, and when contact with the dealer is made, “contact completed” is set. Here, the notification screen is a display screen that displays (notifies) a message including wording prompting the user to contact the dealer and contact information of the dealer. Details of the dealer contact message processing will be described later.

On the other hand, when the operation to contact the dealer has not been selected, the controller 100 determines whether backup has been selected by the user (S140; No → S142).

When backup is selected by the user, the controller 100 executes backup screen processing (S142; Yes → S146).

Here, the backup screen processing is processing in which a backup screen is displayed on the display 140, and when backup is executed, “backup completed” is set. Here, the backup screen refers to a display screen on which backup of the storage medium can be executed. Details of the backup screen processing will be described later.

On the other hand, when backup is not selected by the user, the controller 100 determines whether closing is selected by the user (S142; No → S148).

When closing is not selected by the user, the controller 100 determines whether contacting a dealer is selected by the user (S148; No → S140).

When closing is selected by the user (S148; Yes), and when dealer contact message processing or backup screen processing has been executed, the controller 100 ends the button processing of the warning message.

### 1.4.3 Flow of Dealer Contact Message Processing

FIG. 6 is a diagram illustrating a flow of dealer contact message processing. First, the controller 100 displays a dealer contact message on the display 140 (S152). The dealer contact message may be, for example, a message including contact information of the dealer.

Next, the controller 100 determines whether “contacted” is selected by the user (S154). When the controller 100 determines that “contacted” is selected, the controller 100 assigns a value of “Yes” to the “contact completed” flag (S154; Yes → S158).

On the other hand, when the controller 100 determines that “contacted” is not selected, the controller 100 determines whether “contact later” is selected by the user (S154; No → S156).

When the controller 100 determines that “contact later” is selected, the controller 100 assigns a value of “No” to the “contact completed” flag (S156; Yes → S160).

On the other hand, when the controller 100 determines that “contact later” is not selected, the controller 100 continues to display the dealer contact message on the display 140 (S156; No → S152).

### 1.4.4 Flow of Backup Screen Processing

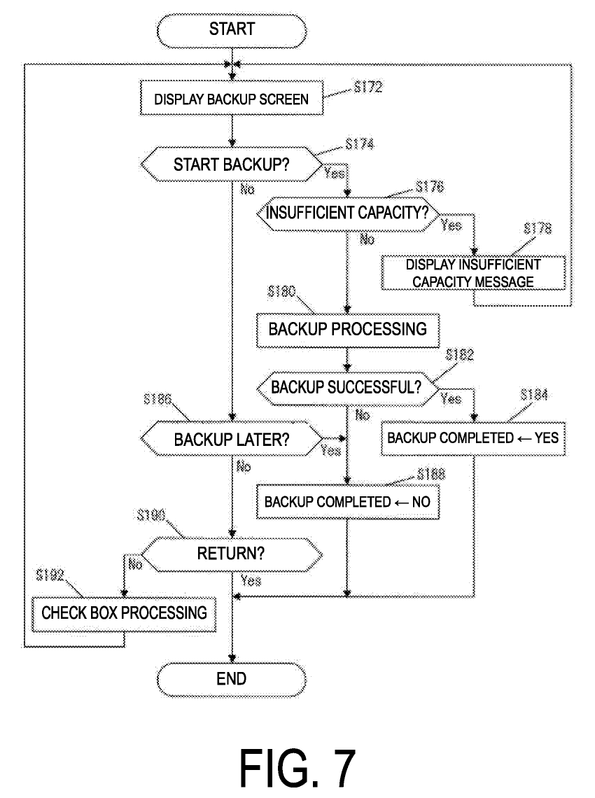

FIG. 7 is a diagram illustrating a flow of backup screen processing. First, the controller 100 displays the backup screen on the display 140 (S172). Next, the controller 100 determines whether “start backup” is selected (S174).

When start backup is selected by the user, the controller 100 determines whether capacity is insufficient (S174; Yes → S176).

On the other hand, when start backup is not selected by the user, the controller 100 determines whether “backup later” is selected (S174; No → S186).

The controller 100 compares a capacity of backup files selected on the backup screen in S172 with a capacity of a backup destination storage medium, and when the capacity of the backup destination storage medium is insufficient, determines that capacity is insufficient.

When capacity is insufficient, the controller 100 displays a capacity-insufficient message on the display 140 (S176; Yes → S178). Subsequently, the controller 100 displays the backup screen again (S178 → S172).

On the other hand, when the controller 100 determines that capacity is not insufficient, the controller 100 executes backup processing (S176; No → S180). Subsequently, the controller 100 determines whether backup has succeeded (S182).

Here, as a method for determining whether backup has succeeded, for example, when backup of at least a part of data to be backed up has been completed, the controller 100 may determine that backup has succeeded.

When backup has succeeded, the controller 100 assigns a value of “Yes” to the “backup completed” flag (S182; Yes → S184).

On the other hand, when backup has not succeeded (S182; No), and when “backup later” is selected by the user (S186; Yes), the controller 100 assigns a value of “No” to the “backup completed” flag (S188).

Further, when “backup later” is not selected by the user, the controller 100 determines whether “return” is selected by the user (S186; No → S190).

When “return” is selected by the user, the controller 100 ends display processing of the backup screen (S190; Yes). On the other hand, when “return” is not selected by the user, the controller 100 executes checkbox processing (S190; No → S192). The checkbox processing is processing for selecting or deselecting checkboxes for selecting data to be backed up.

Note that the above-described operation flow is an example, and partially different processing may be performed. For example, when the determination in S174 is “Yes,” the controller 100 may display a message prompting the user to input an administrator password. Next, the controller 100 may determine whether the administrator password input by the user is “correct,” execute S176 when the password is determined to be “correct,” and execute S186 when the password is determined to be “incorrect”.

Further, as an error check before starting backup, instead of the processing of S176, the controller 100 may determine whether, for example, a USB memory (external storage medium) is connected.

### 1.5 Operation Example

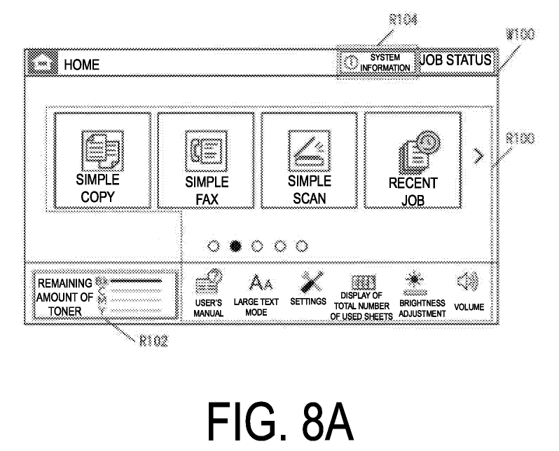

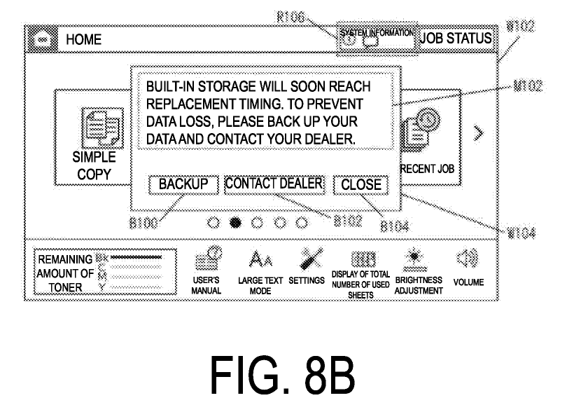

FIGS. 8 to 13 are diagrams illustrating examples of operations of the image forming apparatus 10 in the present embodiment. FIG. 8A is a diagram illustrating an example of an operation of a display screen displayed on the display 140 of the image forming apparatus 10 when an inspection result of the storage medium of the image forming apparatus 10 does not correspond to any of “faulty”, “end of life”, or “replacement timing”.

In a display screen W100 of FIG. 8A, a function display region R100 for displaying various function icons, a display region R102 for displaying status such as remaining toner amount, and a system information display region R104 for displaying system information are provided.

FIG. 8B is a diagram illustrating an example of an operation of a display screen displayed on the display 140 of the image forming apparatus 10 when an inspection result of a storage medium of the image forming apparatus 10 is “replacement timing” and neither “contact completed” nor “backup completed.”

On a display screen W102 of FIG. 8B, a window display (warning screen) W104 for displaying a warning message is displayed, and a system information display region R106 for displaying system information is provided. Here, in the system information display region R106, a speech-bubble icon indicating that there is a notification to the user including a notification that the storage medium is at a replacement timing is displayed. This speech-bubble icon is displayed in the system information display region R106 until the storage medium is replaced by a serviceman.

On the window display W104, a warning message M102 including a first message “The built-in storage will soon reach replacement timing” and a second message “To prevent data loss, please back up your data and contact your dealer” is displayed. That is, a basic-type warning message is displayed as the warning message M102.

Further, on the window display W104, a display button B100 for guiding to a backup screen for executing backup, and a display button B102 for displaying a notification screen that displays contact information of a dealer and prompts the user to contact the dealer are displayed. In addition, a display button B104 for closing the window display W104 is displayed on the window display W104.

Here, when the user selects the display button B100, the controller 100 displays a display screen W110. When the user selects the display button B102, the controller 100 displays a display screen W120. Further, when the user selects the display button B104, the controller 100 displays a display screen W130.

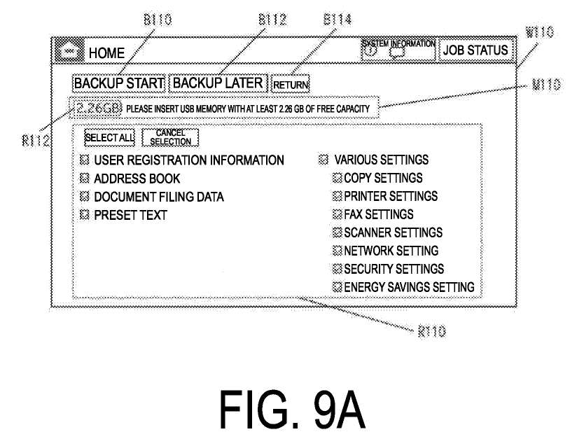

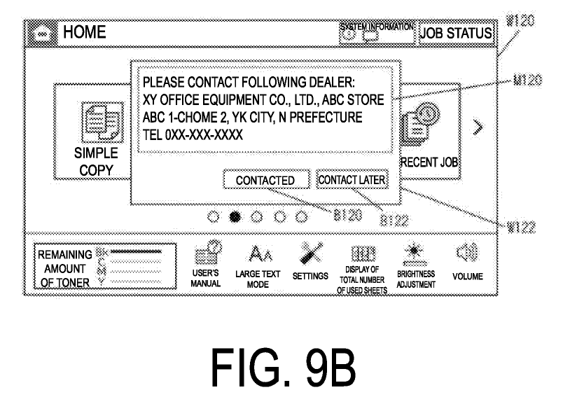

FIG. 9A is a diagram illustrating an example of the operation of the display screen W110 displayed on the display 140 of the image forming apparatus 10 when the user selects the display button B100 in the display screen W102 of the image forming apparatus 10.

On the display screen W110 of FIG. 9A, a data selection region R110 for selecting data to be backed up is provided, and a message M110 “Please insert a USB memory with at least 2.26 GB of free capacity” is displayed. Further, on the display screen W110, a display button B110 for instructing start of backup, a display button B112 for registering that backup will be performed later without performing backup now, and a display button B114 for returning to the display screen W102 are displayed.

Here, when the user selects the display button B110, the controller 100 starts backup processing, stores “backup completed: Yes” when the backup succeeds, stores “backup completed: No” when the backup fails, and redisplays the display screen W102. On the other hand, when the user selects the display button B112, the controller 100 stores “backup completed: No” and redisplays the display screen W102.

It should be noted that, depending on the selected button, a warning message displayed after button selection may be displayed differently. As an example, when the user selects the display button B110, the controller 100 may display a backup-completed-type warning message M160 instead of displaying the basic-type warning message M102 when the backup succeeds.

Further, in the display screen W110, a capacity display region R112 is provided. On the capacity display region R112, a capacity required to back up the data selected as backup targets in the data selection region R110 is displayed. That is, the display screen W110 is a backup screen on which backup of the storage medium can be executed.

FIG. 9B is a diagram illustrating an example of the operation of the display screen W120 displayed on the display 140 of the image forming apparatus 10 when the user selects the display button B102 in the display screen W102 of the image forming apparatus 10.

On the display screen W120 of FIG. 9B, a window display W122 for displaying contact information of a dealer is displayed. On the window display W122, a message M120 prompting the user to contact a dealer and indicating contact information of the dealer, such as “Please contact the following dealer: XY Office Equipment Co., Ltd., ABC Store, ABC 1-chome 2, YK City, N Prefecture, Tel: 0XX-XXX-XXXX,” is displayed.

Further, on the window display W122, a display button B120 for registering that the dealer has been contacted and a display button B122 for registering that the dealer will be contacted later are displayed. That is, the display screen W120 is a notification screen for notifying the user of the dealer contact information.

Here, when the user selects the display button B120, the controller 100 stores “contact completed: Yes” and redisplays the display screen W102. Note that, instead of the basic-type warning message M102 displayed on the display screen W102, a contact completed-type warning message M140 may be displayed.

On the other hand, when the user selects the display button B122, the controller 100 stores “contact completed: No” and redisplays the display screen W102. When the user selects the display button B104, the controller 100 ends the display of the warning message and transitions to the display screen W130.

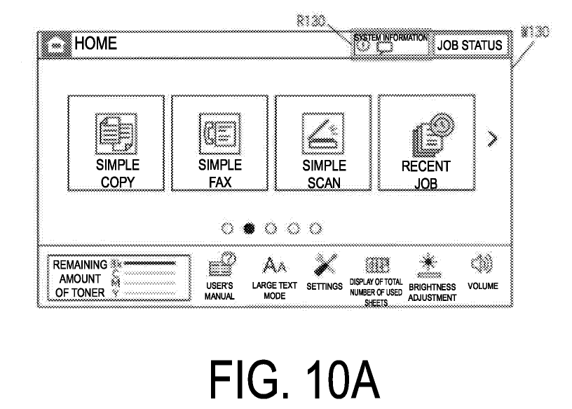

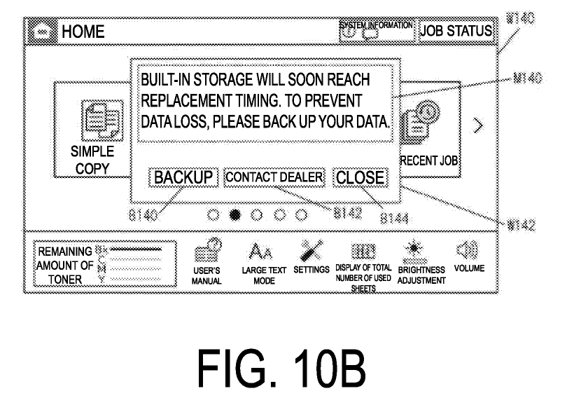

FIG. 10A is a diagram illustrating an example of the operation of the display screen W130 displayed on the display 140 of the image forming apparatus 10 when the user selects the display button B104 on the display screen W102 of the image forming apparatus 10.

In the display screen W130 of FIG. 10A, a system information display region R130 for displaying system information is provided. Here, in the system information display region R130, a speech-bubble icon indicating that there is a notification to the user including that the storage medium is at a replacement timing is displayed. When the user selects the speech-bubble icon displayed in the system information display region R130, the controller 100 displays a display screen including notification content related to the replacement timing of the storage medium. When the notification content related to the replacement timing of the storage medium is selected on this display screen, the display screen W102 including the warning message M102 is redisplayed.

FIG. 10B is a diagram illustrating an example of the operation of a display screen displayed on the display 140 of the image forming apparatus 10 when the inspection result of the storage medium of the image forming apparatus 10 is “replacement timing” and is “contact completed”.

On a display screen W140 of FIG. 10B, a window display W142 for displaying a warning message is displayed. On the window display W142, the contact completed-type warning message M140 including a first message “The built-in storage will soon reach replacement timing” and a second message “To prevent data loss, please back up your data” is displayed.

Here, the second message displays only a message prompting backup, and a message prompting contact with a dealer is not displayed; that is, a warning message changed from the warning message M102 is displayed. In other words, the contact completed-type warning message is displayed as the warning message M140.

Further, on the window display W142, a display button B140 for guiding to a backup screen for executing backup and a display button B142 for displaying a notification screen for prompting contact with a dealer are displayed. In addition, on the window display W142, a display button B144 for closing the window display W142 is displayed.

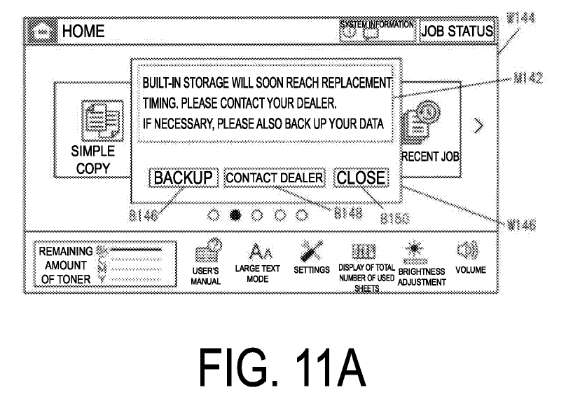

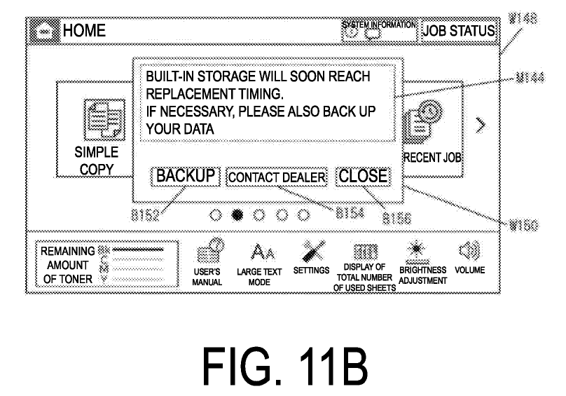

FIG. 11A is a diagram illustrating an example of the operation of a display screen displayed on the display 140 of the image forming apparatus 10 when the inspection result of the storage medium of the image forming apparatus 10 is “replacement timing” and is “backup completed”.

On a display screen W144 of FIG. 11A, a window display W146 for displaying a warning message is displayed. On the window display W146, a warning message M142 including a first message “The built-in storage will soon reach replacement timing” and a second message “Please contact your dealer. If necessary, please also back up your data” is displayed.

Here, the second message is displayed as a message that prompts the user to contact a dealer and the message is changed to a message that prompts the user to perform backup as necessary. That is, on the warning message M142, a backup-completed-type warning message is displayed.

Further, on the window display W146, the display button B146 for guiding to a backup screen for executing backup and a display button B148 for displaying a notification screen for prompting contact with a dealer are displayed. Further, on the window display W146, a display button B150 for closing the window display W146 is displayed.

FIG. 11B is a diagram illustrating an example of an operation of a display screen displayed on the display 140 of the image forming apparatus 10 when an inspection result of a storage medium of the image forming apparatus 10 is a “replacement timing” and is “contact completed” and “backup completed”.

On a display screen W148 of FIG. 11B, a window display W150 for displaying a warning message is displayed. On the window display W150, a warning message M144 including a first message “The built-in storage will soon reach replacement timing” and a second message “If necessary, please also back up your data” is displayed.

Here, the second message is displayed as a message that prompts the user to contact a dealer and the message is changed to a message that prompts the user to perform backup as necessary. That is, on the warning message M144, a contact-completed-and-backup-completed-type warning message is displayed.

Further, on the window display W150, a display button B152 for guiding to a backup screen for executing backup and a display button B154 for displaying a notification screen for prompting contact with a dealer are displayed. Further, on the window display W150, a display button B156 for closing the window display W150 is displayed.

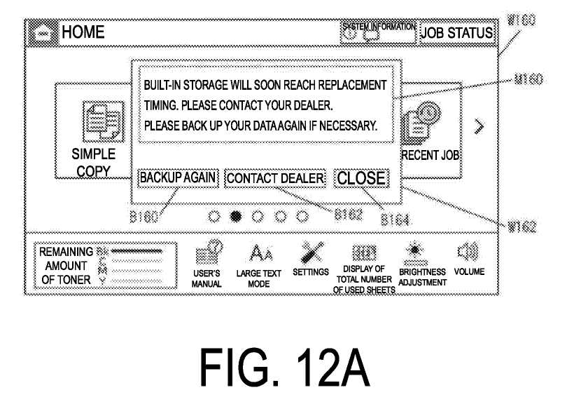

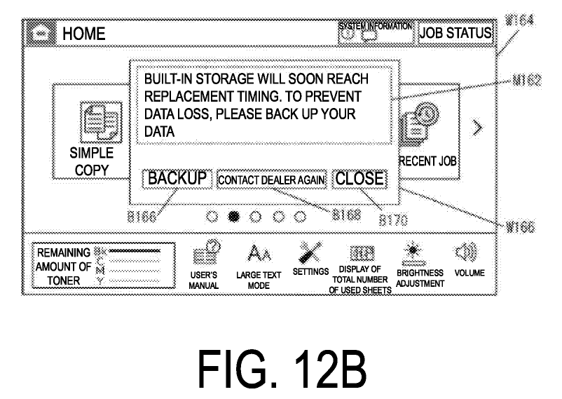

FIG. 12A is a diagram illustrating an example different from the display screen W144 of an operation of a display screen displayed on the display 140 of the image forming apparatus 10 when an inspection result of a storage medium of the image forming apparatus 10 is a “replacement timing” and is “backup completed”.

On the display screen W160 of FIG. 12A, a window display W162 for displaying a warning message is displayed. On the window display W162, a backup-completed-type warning message M160 including a first message “The built-in storage will soon reach replacement timing” and a second message “Please contact your dealer. Please back up your data again if necessary.” is displayed.

Further, on the window display W162, a display button B160 for guiding to a backup screen for executing backup and a display button B162 for displaying a notification screen for prompting contact with a dealer are displayed. Further, on the window display W162, a display button B164 for closing the window display W162 is displayed.

Here, the display button B160 is displayed as “Backup again” and is changed from “Backup” of the display button B146. The controller 100 may display the message M160 without including the message “Please back up your data again if necessary” and may hide the display button B160. When the user selects the display button B160, the controller 100 displays the display screen W130.

FIG. 12B is a diagram illustrating an example different from the display screen W140 of an operation of a display screen displayed on the display 140 of the image forming apparatus 10 when an inspection result of a storage medium of the image forming apparatus 10 is a “replacement timing” and is “contact completed”.

On a display screen W164 of FIG. 12B, a window display W166 for displaying a warning message is displayed. On the window display W166, a contact completed-type warning message M162 including a first message “The built-in storage will soon reach replacement timing” and a second message “To prevent data loss, please back up your data” is displayed.

Further, on the window display W166, a display button B166 for guiding to a backup screen for executing backup and a display button B168 for displaying a notification screen for prompting contact with a dealer are displayed. In addition, on the window display W166, a display button B170 for closing the window display W166 is displayed.

Here, the display button B168 is displayed as “Contact the dealer again”, and is changed from “Contact the dealer” of the display button B142. The display button B168 may be hidden. When the user selects the display button B168, the controller 100 displays the display screen W120.

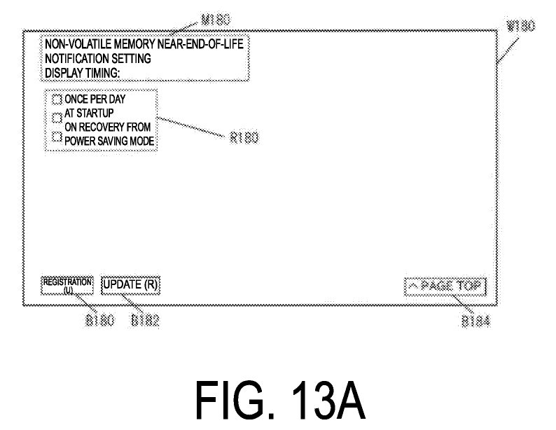

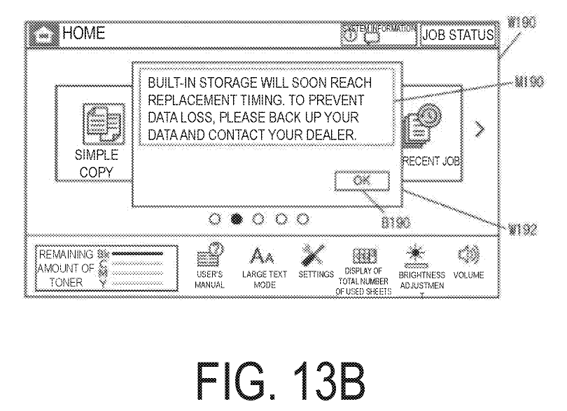

FIG. 13A is a diagram illustrating an example of an operation of a display screen (system setting screen) displayed on the display 140 of the image forming apparatus 10 for setting timing at which the image forming apparatus 10 displays each warning message.

On a display screen W180 of FIG. 13A, a message M180 “Non-volatile Memory Near-End-of-Life Notification Setting Display Timing:” is displayed. Further, on the display screen W180, a setting area R180 in which a user can set timing for displaying a warning message related to the storage medium is provided. In addition, on the display screen W180, a display button B180 for registering settings, a display button B182 for updating settings, and a display button B184 for returning to a top of a page are displayed.

FIG. 13B is a diagram illustrating an example different from the display screen W102 of an operation of a display screen displayed on the display 140 of the image forming apparatus 10 in a case where an inspection result of a storage medium of the image forming apparatus 10 indicates a “replacement timing” and neither “contact completed” nor “backup completed” is satisfied.

On the display screen W190 of FIG. 13B, a window display W192 for displaying a warning message is displayed. On the window display W192, a basic-type warning message M190 including a first message “The built-in storage will soon reach replacement timing” and a second message “To prevent data loss, please back up your data and contact your dealer” is displayed.

Further, on the window display W192, a display button B190 for closing the warning message (window display W192) is displayed. When the user selects the display button B190, the controller 100 displays the display screen W130.

### 1.6 Effects, etc.

According to the present embodiment, for example, it is possible to provide an information processing apparatus and the like capable of appropriately notifying a user at a replacement timing of a storage medium.

In addition to detecting a storage failure, a replacement timing of a storage medium whose lifetime is near is detected. When the lifetime of the storage is near, the user can be prompted to “contact a dealer” and “perform backup”. The storage includes storage contents present from factory shipment and storage contents derived from a user. Only the latter needs to be backed up, and a backup function for an administrator can be provided. As a result, it becomes possible to replace the storage before reaching the end of its lifetime, thereby preventing loss of customer data due to storage replacement after the lifetime has been reached. An information processing apparatus capable of minimizing degradation of customer satisfaction and service costs can be provided.

### 2. Modification Examples

The disclosure is not limited to the embodiments described above and can be modified in various ways.

In other words, embodiments obtained by combining technical mechanisms appropriately changed without departing from the gist of the disclosure are also included in the technical scope.

Although the above-described embodiments have been separately described for convenience of description, the embodiments can be combined and executed within an allowable range. The right of any of the technologies described herein is intended to be acquired through amendment, divisional application, or the like.

The programs running on each apparatus in the embodiments are programs for controlling a CPU or the like (programs for causing a computer to function) to implement the aforementioned functions in the embodiments. Information handled by these apparatuses is temporarily accumulated in a transitory storage apparatus (for example, a RAM) at the time of processing, is then stored in a storage apparatus such as any of various ROMs or an HDD, and is read, corrected, and written by the CPU as needed.

The recording medium storing the programs may be any of a semiconductor medium (for example, a ROM, a non-volatile memory card, or the like), an optical recording medium or a magneto-optical recording medium (for example, a Digital Versatile Disc (DVD), a Compact Disc (CD), a Blu-ray (trade name) Disc (BD) or the like), a magnetic recording medium (for example, a magnetic tape, a flexible disk, or the like), and the like.

In a case where the programs are distributed to market, the programs can be stored and distributed in a portable recording medium, or can be transferred to a server computer connected via a network such as the Internet. In this case, it is a matter of course that the storage apparatus of the server apparatus is also included in the disclosure.

Instead of being stored in the apparatus, the above-described data may be stored in an external apparatus and called as appropriate. For example, the data may be stored in a network attached storage (NAS) or may be stored on a cloud.

It should be noted that the scope of the disclosure is not limited to the configurations explicitly described in the present specification, and a combination of technologies disclosed herein is also included in the scope thereof. Configurations of the disclosure sought to be patented are set forth in the appended claims, but configurations not recited in the claims are not intended to be excluded from the technical scope.

In the above-described specification, the descriptions "in a case in which ..." and "when ..." are described as examples, and the configuration is not limited to the described contents. Configurations not indicated by the descriptions "in a case in which ..." and "when ..." are also disclosed to the extent that the configurations are obvious to those skilled in the art, and the rights thereof are intended to be acquired.

The processing and the flow of data have been described herein in order, but the order thereof is not limited to the described order. For example, a configuration in which processing is partly removed or the order is rearranged is also disclosed, and the right thereof is intended to be acquired.

Although the functions described in the embodiments are described as being performed in the respective apparatuses, the functions may be implemented in one apparatus or by using an external server.

In addition, each functional block or various features of the apparatus used in the above-described embodiments may be implemented or executed by an electric circuit such as, for example, an integrated circuit or a plurality of integrated circuits. An electric circuit designed to perform the functions described in the present specification may include a general-purpose processor, a digital signal processor (DSP), an application specific integrated circuit (ASIC), a field programmable gate array (FPGA) or other programmable logic apparatus, discrete gate or transistor logic, discrete hardware components, or a combination thereof. The general-purpose processor may be a microprocessor or may be a known processor, controller, microcontroller, or state machine. The electric circuit described above may include a digital circuit or may include an analog circuit. Further, when an integrated circuit technology for replacement into a current integrated circuit emerges with the development of semiconductor technology, a new integrated circuit based on the technology may also be used in one or more aspects of the disclosure.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An information processing apparatus comprising:
a display;
a storage medium;
an inspector that inspects the storage medium; and
one or more controllers, wherein
the one or more controllers,
when an inspection result indicating that a state of the storage medium is a replacement timing is obtained by an inspection by the inspector, display, on the display, a warning screen including a first message notifying the replacement timing of the storage medium, and a second message prompting backup of the storage medium and contact with a dealer.

2. The information processing apparatus according to claim 1, wherein the one or more controllers,
when at least one of backup of the storage medium and contact with the dealer has been executed, change display content of the second message and display the warning screen on the display.

3. The information processing apparatus according to claim 1, wherein the one or more controllers
display, on the warning screen, a button that guides to a backup screen where the backup of part or all of the storage medium is executed.

4. The information processing apparatus according to claim 3, wherein the one or more controllers,
when an inspection result indicating that the storage medium is faulty or at the end of its service life is obtained by an inspection by the inspector, disable the backup, andenables the backup in a case where the backup is performed by a service person of the dealer.

5. The information processing apparatus according to claim 1, wherein the one or more controllers
display, on the warning screen, a button that displays a notification screen displaying contact information of the dealer.

6. The information processing apparatus according to claim 1, wherein the one or more controllers
display, on the display, an icon including a notification related to a replacement timing of the storage medium until the storage medium is replaced.

7. The information processing apparatus according to claim 1, wherein the one or more controllers
display the warning screen on the display at at least one timing among when the information processing apparatus is activated, when the information processing apparatus returns from a power-saving mode, or at a predetermined time.

8. The information processing apparatus according to claim 7, wherein the one or more controllers
display, on the display, a display screen that allows the timing at which the warning screen is displayed to be set.

9. The information processing apparatus according to claim 1, wherein the storage medium is a NAND-type non-volatile storage medium.

10. A display method comprising:
an inspection step of inspecting a storage medium; and
when an inspection result indicating that a state of the storage medium is a replacement timing is obtained by an inspection in the inspection step, a displaying step of displaying a warning screen including a first message notifying the replacement timing of the storage medium, and a second message prompting backup of the storage medium and contact with a dealer.
